(19) United States
(12) Patent Application Publication
(10) Pub. No.: US 2005/0138333 A1
(43) Pub. Date: Jun. 23, 2005

(54) Thread switching mechanism

(76) Inventor: Nicholas G. Samra, Austin, TX (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/741,960

(22) Filed: Dec. 19, 2003

(51) Int. Cl. G06F 9/30

(52) U.S. Cl. 712/218

(57) ABSTRACT

Method, apparatus and system embodiments provide support for multiple SoEMT software threads on multiple SMT logical processors. A thread switch on a given logical processor may be accomplished without interrupting operation of other physical threads. Microarchitectural state for a current virtual thread is “torpedoed” at a torpedo point before a new virtual thread begins operating on the given logical processor. For at least one embodiment, the torpedo mechanism clears microarchitectural state for the current virtual thread, freeing most microarchitectural resources associated with torpedoed instructions. Such mechanism does not interrupt processing of other physical thread(s) and also does not require hardware overhead associated with maintaining in the processor microarchitectural state associated with inactive threads.

### BACKGROUND

1. Technical Field

The present disclosure relates generally to information processing systems and, more specifically, to a thread switching mechanism that torpedoes microarchitectural state for one of multiple SoEMT threads on a first physical thread without interrupting processing on a second physical thread.

2. Background Art

In order to increase performance of information processing systems, such as those that include microprocessors, both hardware and software techniques have been employed. On the hardware side, microprocessor design approaches to improve microprocessor performance have included increased clock speeds, pipelining, branch prediction, super-scalar execution, out-of-order execution, and caches. Many such approaches have led to increased transistor count, and have even, in some instances, resulted in transistor count increasing at a rate greater than the rate of improved performance.

Rather than seek to increase performance through additional transistors, other performance enhancements involve software techniques. One software approach that has been employed to improve processor performance is known as “multithreading.” In software multithreading, an instruction stream may be into multiple instruction streams that can be executed in parallel. Alternatively, two independent software streams may be executed in parallel.

In one approach, known as time-slice multithreading or time-multiplex (“TMUX”) multithreading, a single processor switches between threads after a fixed period of time. In still another approach, a single processor switches between threads upon occurrence of a trigger event, such as a long latency cache miss. In this latter approach, known as switch-on-event multithreading (“SoEMT”), only one thread, at most, is active at a given time.

Increasingly, multithreading is supported in hardware. For instance, in one approach, processors in a multi-processor system, such as a chip multiprocessor (“CMP”) system, may each act on one of the multiple threads simultaneously. In another approach, referred to as simultaneous multithreading (“SMT”), a single physical processor is made to appear as multiple logical processors to operating systems and user programs. For SMT, multiple threads can be active and execute simultaneously on a single processor without switching. That is, each logical processor maintains a complete set of the architecture state, but many other resources of the physical processor, such as caches, execution units, branch predictors, control logic and buses are shared. For SMT, the instructions from multiple software threads thus execute concurrently on each logical processor.

### BRIEF DESCRIPTION OF THE DRAWINGS

The present invention may be understood with reference to the following drawings in which like elements are indicated by like numbers. These drawings are not intended to be limiting but are instead provided to illustrate selected embodiments of an apparatus, system and methods for effecting a thread switch among virtual SoEMT software threads on one of a plurality of multiple SMT logical thread contexts.

FIG. 1 is a block diagram of at least one embodiment of a processor capable of utilizing disclosed techniques to perform a thread switch.

FIG. 2 is a flowchart illustrating at least one embodiment of a method for performing a thread switch among virtual SoEMT threads.

FIG. 3 is a block diagram illustrating at least one embodiment of a retirement queue and a torpedo pointer.

FIG. 4 is a block diagram of a processing system capable of performing a thread switch according to at least one disclosed embodiment.

FIG. 5 is a flowchart illustrating further details for at least one embodiment of the method illustrated in FIG. 2.

### DETAILED DESCRIPTION

In the following description, numerous specific details such as processor types, multithreading environments, and microarchitectural structures have been set forth to provide a more thorough understanding of the present invention. It will be appreciated, however, by one skilled in the art that the invention may be practiced without such specific details. Additionally, some well known structures, circuits, and the like have not been shown in detail to avoid unnecessarily obscuring the present invention.

A particular hybrid of multithreading approaches is disclosed herein. Particularly, a combination of SoEMT and SMT multithreading approaches is referred to herein as “Virtual Multithreading”. For SMT, two or more software threads may run concurrently on separate logical contexts. For SoEMT, only one of multiple software threads is active in a logical context at any given time. These two approaches are combined in Virtual Multithreading. In Virtual Multithreading, each of two or more logical contexts supports two or more SoEMT software threads, referred to as “virtual threads.”

For example, three virtual software threads may run on an SMT processor that supports two separate logical thread contexts. Any of the three software threads may begin running, and then go into an inactive state upon occurrence of an SoEMT trigger event.

Because expiration of a TMUX multithreading timer may be considered a type of SoEMT trigger event, the use of the term “SoEMT” with respect to the embodiments described herein is intended to encompass multithreading wherein thread switches are performed upon the expiration of a TMUX timer, as well as upon other types of trigger events, such as a long latency cache miss, execution of a particular instruction type, and the like.

When resumed, an inactive software thread need not resume in the same logical context in which it originally began execution—it may resume either in the same logical context or on the other logical context. In other words, a virtual software thread may switch back and forth among logical contexts over time.

Disclosed herein is a mechanism to perform a thread switch from one virtual thread to another on a particular logical processor. As used herein, the “current virtual thread” is intended to indicate the currently running virtual thread on a given logical processor for which a thread switch has been indicated. The “current virtual thread” is therefore designated to become inactive upon the thread switch; it is the virtual thread being switched “from”. The “new virtual thread” is the currently inactive thread that will become active on the given logical processor as a result of the thread switch; it is the virtual thread being switched “to.”

On an SMT processor, as is stated above, each logical processor maintains a complete set of the architecture state. Upon a thread switch, the architectural state for the active virtual thread on a logical processor is saved before the switch is effected. (The active virtual thread on a logical processor before a thread switch is sometimes referred to herein as the “current” virtual thread).

However, the microarchitectural state for a current virtual thread may be flushed, or “torpedoed,” from the SMT processor when a switch to a new virtual thread is desired. Embodiments of the mechanism disclosed herein provides for a flush or “torpedo” of the microarchitectural state for a physical thread during a software thread switch, but with minimal hardware overhead costs and without interrupting the processing of other physical threads.

Method, apparatus and system embodiments disclosed herein provide for a thread switch on a given logical processor (also referred to herein as a “physical thread”) that may be accomplished without interrupting operation of other physical threads. Microarchitectural state for a current virtual thread is “torpedoed” at a given torpedo point before a new virtual thread begins operating on the given physical thread. For at least one embodiment, the torpedo mechanism clears microarchitectural state for the current virtual thread, freeing most microarchitectural resources associated with torpedoed instructions, but without affecting the microarchitectural state for other physical threads. Such mechanism does not interrupt processing of other physical thread(s) and also does not require hardware overhead associated with maintaining in the processor microarchitectural state associated with inactive threads.

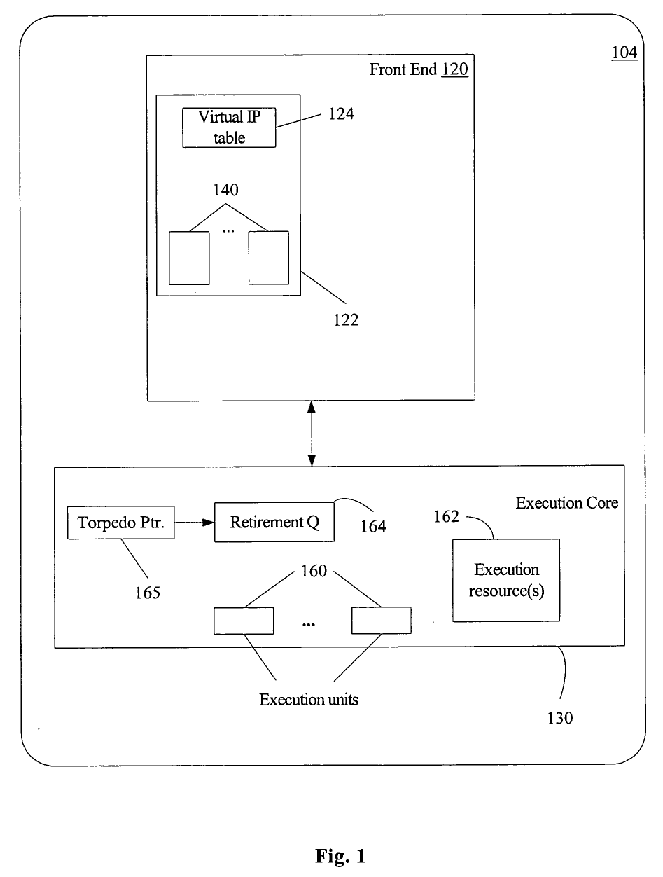

FIG. 1 is a block diagram illustrating a processor 104 capable of performing disclosed techniques to swap from one virtual thread to another on a physical thread in a manner that minimizes hardware overhead. The processor 104 may include a front end 120 that prefetches instructions that are likely to be executed.

For at least one embodiment, the front end 120 includes a fetch/decode unit 122 that includes logically independent sequencers 140 for each of one or more logical processors. The logical processors may also be interchangeably referred to herein as “physical threads.” The single physical fetch/decode unit 122 thus includes a plurality of logically independent sequencers 140, each corresponding to a physical thread.

FIG. 1 illustrates that at least one embodiment of the front end 120 includes a virtual instruction pointer (“IP”) table 124. The virtual IP table 124 maintains the next instruction pointer value for each inactive virtual thread. When an inactive thread becomes active, upon a thread switch, the next instruction pointer value for the new virtual thread is obtained from the virtual IP table 124. The sequencer 140 for the physical thread upon which the thread switch is being performed then begins fetching instructions at the next instruction pointer value obtained from the virtual IP table 124.

FIG. 1 illustrates that at least one embodiment of processor 104 includes an execution core 130 that prepares instructions for execution, executes the instructions, and retires the executed instructions. The execution core 130 may include out-of-order logic to schedule the instructions for out-of-order execution. The execution core 130 may include one or more resources 162 that it utilizes to smooth and re-order the flow of instructions as they flow through the execution pipeline and are scheduled for execution. These resources may include one or more of a an instruction queue to maintain unscheduled instructions, memory ordering buffer, load request buffers to maintain entries for uncompleted load instructions, store request buffers to maintain entries for uncompleted store instructions, and the like.

The execution core 130 may include retirement logic that reorders the instructions, executed in an out-of-order manner, back to the original program order. Such retirement logic may include a retirement queue 164 to maintain information for instructions in the execution pipeline until such instructions are retired. The retirement logic may receive the completion status of the executed instructions from execution units 160 and may process the results so that the proper architectural state is committed (or retired) according to the program order.

Of course, one of skill in the art will recognize that the execution core 130 may process instructions in program order and need not necessarily provide out-of-order processing. In such case, the retirement queue 164 is not a reorder buffer, but is merely a buffer that tracks instructions, in program order, until such instructions are retired. Similarly, the execution resources 162 for such an in-order processor do not include structures whose function is to re-order and track instructions for out-of-order processing.

FIG. 1 illustrates that the execution core 130 may also include a torpedo pointer 165. For a thread switch, the torpedo pointer 165 may include a data value to indicate an entry of the retirement queue 164. The entry of the retirement queue 164 indicated by the torpedo pointer 165 is the oldest instruction of a current virtual thread that should be torpedoed for the indicated thread switch. The identified torpedo point is thus the oldest non-worthwhile unretired instruction for the current virtual thread.

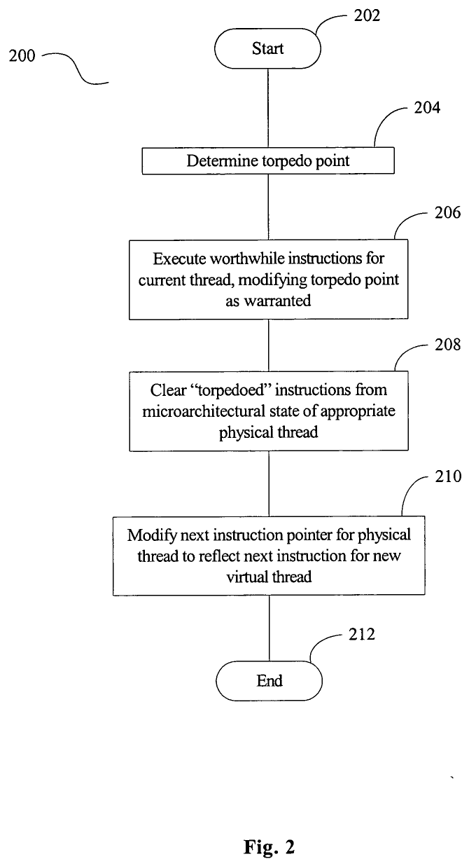

FIG. 2 is a flowchart illustrating a method 200 for “torpedoing” (flushing) the microarchitectural state for a virtual thread upon a thread switch from one SoEMT virtual software thread to another on a given physical thread. Rather than employing hardware to track instructions for every virtual thread, the method 200 provides for flushing unretired instructions for a current virtual thread out of the processor upon a thread switch.

FIG. 2 illustrates that the method 200 begins at block 202 and proceeds to block 204. At block 204, a “torpedo point” is determined. The torpedo point indicates an instruction in the instruction stream of the current virtual thread (the virtual thread that is to be swapped out and made inactive). The torpedo point is the instruction that will cause the virtual thread switch; the torpedo point is analogous to an instruction that causes an exception.

For a thread switch, the torpedo point, along with instructions younger than the torpedo point, are to be flushed, or “torpedoed,” from the execution pipeline and any supporting microarchitectural structures. Upon re-activation, the torpedo point is the first instruction that will be executed by the current virtual thread. As used herein, a “younger” instruction is an instruction is one that is issued relatively later according to program order.

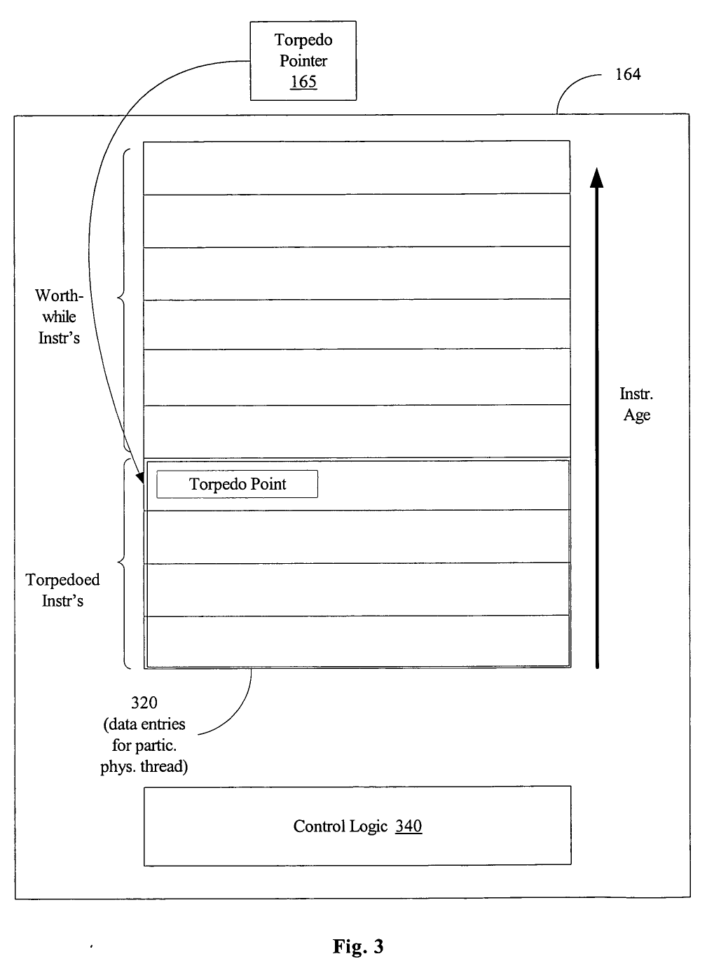

Further discussion of method 200 is made with reference to FIG. 3. FIG. 3 is a block diagram illustrating a retirement queue 164 and torpedo pointer 165. The retirement queue 164 may include data entries 320 as well as control logic 340. For at least one embodiment, most of the blocks of method 200 are performed by control logic 340.

For at least one embodiment, the data entries 320 of the retirement queue make up a structure, such as a re-order buffer, that maintains an entry for each instruction in the instruction pipeline that has not yet been retired. It is assumed that some mechanism is employed to associate the entries of the retirement queue 164 with the appropriate physical thread.

For at least one embodiment, such function is accomplished by partitioning the retirement queue 164 such that specified contiguous entries of the retirement queue 164 are allocated for a particular physical thread. For example, the x entries of a retirement queue may be partitioned such that each block of x/n contiguous entries is allocated for one of n physical threads. For at least one other embodiment, each entry of the retirement queue 164 is associated with a physical thread identifier.

As illustrated in FIG. 3, the data entries 320 of the retirement queue 164 for a particular physical thread are maintained in program order for the active virtual thread, from youngest instruction to oldest instruction. For example, the oldest instruction may be the instruction that is to be retired next for the particular virtual thread.

FIG. 3 further illustrates that the retirement queue 164 may also include control logic 340. Control logic 340 may be responsible for determining the torpedo point at block 204, and for performing other blocks of method 200 as discussed below.

FIG. 3 illustrates that a torpedo point is an identification of the instruction in the retirement queue 164 that is the first instruction to be executed when the current virtual thread (which is being inactivated for the current thread switch) is re-activated. In other words, the torpedo point is the oldest instruction in the current virtual thread instruction stream to be torpedoed for the current thread switch.

Such torpedo point is identified at block 204 of FIG. 2. A pointer to the entry of the retirement queue 164 that holds information for the torpedo point identified at block 204 may be maintained in the torpedo pointer 165. The torpedo point identified at block 204 may be, for instance, an instruction that has caused a thread-switch trigger event, such as a load instruction that has triggered a cache miss. In another instance, the torpedo point may be an instruction identified by the retirement queue 164 control logic 340 in response to a thread switch trigger event not related to execution of an instruction, such as expiration of a timer.

Processing for method 200 proceeds from block 204 to block 206. At block 206, the “worthwhile” instructions older than the torpedo point are permitted to complete execution and retire. It will be understood that some instructions indicated in the “worthwhile” entries of the retirement queue 164 may have already completed execution. Processing then proceeds to block 208.

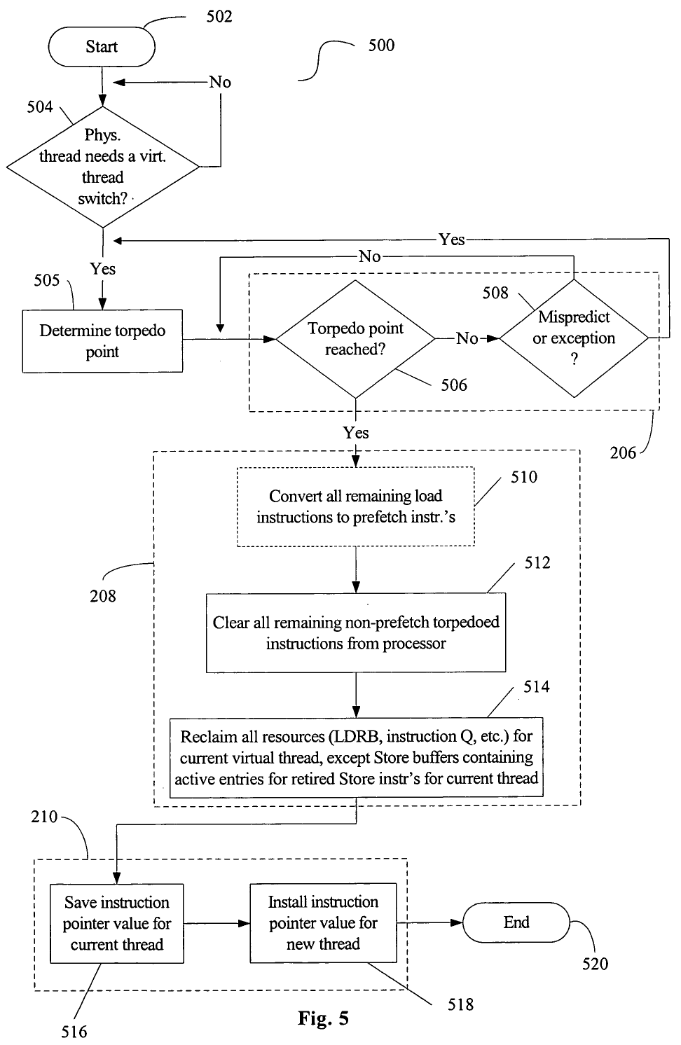

At block 208, the torpedoed instructions are cleared from the microarchitectural state of the processor. In this manner, the unretired instruction younger than the torpedo instruction are “torpedoed;” the torpedoed instructions are not executed for the current virtual thread, but are cleared from the machine. (Some embodiments may allow certain “torpedoed” instructions to remain in certain microarchitectural structures, but in a manner that will not change the architectural state. This is discussed below in connection with FIG. 5).

One will note that only pending instructions for the current virtual thread for a particular physical thread are torpedoed at block 208. Instructions for virtual threads active on one or more other physical threads may continue execution uninterrupted in spite of a torpedo on the given physical thread.

From block 208, processing for the method 200 proceeds to block 210. At block 210, the control logic 340 may indicate to the front end (see, e.g. 120 of FIG. 1) that the next instruction pointer for the new active virtual thread (the virtual thread being switched to) should be retrieved from the virtual IP thread table 124 and provided to the sequencer 140 for the physical thread undergoing the thread switch, so that execution on the physical thread may begin at the next instruction for the newly active virtual thread.

In addition, the control logic 340 may also indicate that the next instruction pointer for the current virtual thread (the virtual thread being made inactive) should be saved in the virtual thread IP table 124. From block 210, processing ends at block 212.

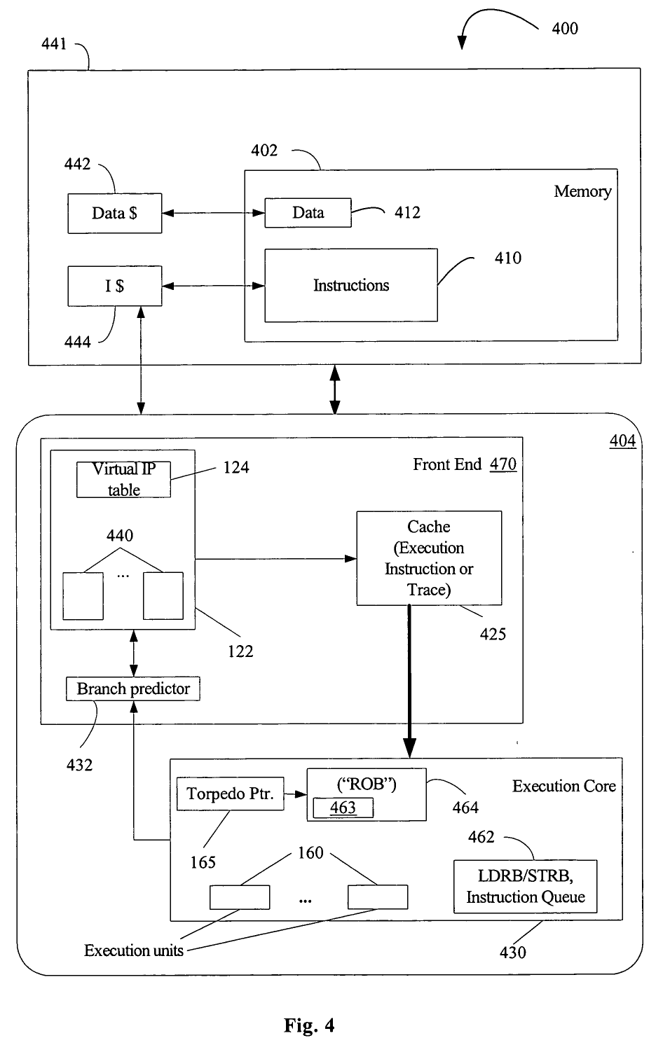

FIG. 4 is a block diagram illustrating at least one embodiment of a computing system 400 capable of performing the disclosed techniques to switch among virtual threads for a physical context, without interrupting execution of a virtual thread in another physical context. The computing system 400 includes a processor 404 and a memory 402. Memory 402 may store instructions 410 and data 412 for controlling the operation of the processor 404.

The processor 404 may include a front end 470 along the lines of front end 120 described above in connection with FIG. 1. Front end 470 supplies instruction information to an execution core 430. For at least one embodiment, the front end 470 may supply the instruction information to the execution core 430 in program order.

The front end 470 may include a virtual IP table 124, as well as a fetch/decode unit 122 having multiple independent logical sequencers 440 for multiple logical processors.

For at least one embodiment, the front end 470 prefetches instructions that are likely to be executed. A branch prediction unit 432 may supply branch prediction information in order to help the front end 470 determine which instructions are likely to be executed.

At least one embodiment the execution core 430 prepares instructions for out-of-order execution, executes the instructions, and retires the executed instructions. The execution core 430 may include a torpedo pointer 165 and may also include out-of-order logic to schedule the instructions for out-of-order execution. The execution resources for 462 for the processor 404 may include an instruction queue, load request buffers and store request buffers.

The execution core 430 may also include one or more reorder buffers 464. That is, a single reorder buffer 464 may maintain unretired instruction information for all logical processors 140. Alternatively, a separate reorder buffer 464 may be maintained for each logical processor 140. Each reorder buffer 464 may include control logic 463 along the lines of control logic 340 discussed above in connection with FIG. 3.

The execution core 430 may include retirement logic that reorders the instructions, executed in an out-of-order manner, back to the original program order in a retirement queue 164. This retirement logic receives the completion status of the executed instructions from the execution units 160. The retirement logic may also report branch history information to the branch predictor 432 at the front end 470 of the processor 404 to impart the latest known-good branch-history information.

As used herein, the term “instruction information” is meant to refer to basic units of work that can be understood and executed by the execution core 430. Instruction information may be stored in a cache 425. The cache 425 may be implemented as an execution instruction cache or an execution trace cache. For embodiments that utilize an execution instruction cache, “instruction information” includes instructions that have been fetched from an instruction cache and decoded. For embodiments that utilize a trace cache, the term “instruction information” includes traces of decoded micro-operations. For embodiments that utilize neither an execution instruction cache nor trace cache, “instruction information” also includes raw bytes for instructions that may be stored in an instruction cache (such as I-cache 444).

The processing system 400 includes a memory subsystem 441 that may include one or more caches 442, 444 along with the memory 402. Although not pictured as such in FIG. 4, one skilled in the art will realize that all or part of one or both of caches 442, 444 may be physically implemented as on-die caches local to the processor 404. The memory subsystem 441 may be implemented as a memory hierarchy and may also include an interconnect (such as a bus) and related control logic in order to facilitate the transfer of information from memory 402 to the hierarchy levels. One skilled in the art will recognize that various configurations for a memory hierarchy may be employed, including non-inclusive hierarchy configurations.

It will be apparent to one of skill in the art that, although only an out-of-order processing system 400 is illustrated in FIG. 4, the embodiments discussed herein are equally applicable to in-order processing systems as well. Such in-order processing systems typically do not include ROB 464. Nonetheless, such in-order systems may still include a retirement queue (see 164, FIG. 1) in order to track unretired instructions.

FIG. 5 is a flowchart illustrating further detail of an embodiment of the method 200 illustrated in FIG. 2, where such method is performed by an embodiment of a processing system 400 such as that illustrated in FIG. 4. FIG. 5 will be discussed below with reference to FIG. 4.

FIG. 5 illustrates that the method 500 begins at block 502 and proceeds to block 504. At block 504 it is determined whether a thread switch is desired on one of the logical processors. If so, processing proceeds to block 505. Otherwise, processing loops back to block 504. Although the determination 504 of a thread switch event is illustrated as a polling loop in FIG. 5, one of skill in the art will recognize that such determination 504 could easily be made, in the alternative, via an exception or some other passive event determination method.

If a thread switch is indicated, processing proceeds to block 505. At block 505, the torpedo point is determined, as is discussed above in connection with block 204 of FIG. 2. Processing then proceeds to block 506.

FIG. 5 illustrates that blocks 506 and 508 illustrate at least on embodiment of further details for the processing of block 206 illustrated in FIG. 2. At block 506, it is determined whether the torpedo point has been reached during execution of the instructions in the pipeline for the current virtual thread. If so, then processing proceeds to block 510. Otherwise, processing proceeds to block 508.

At block 508, it is determined whether execution of the most-recently-executed instruction has caused an exception. At block 508 it is also determined whether a branch misprediction has been detected. If either condition is true, processing proceeds back to block 505. At block 505, the torpedo point is adjusted. For exceptions, the instruction that has caused the exception is the new torpedo point. For a mispredicted branch instruction, the new torpedo point is adjusted at block 505 to reflect the first instruction on the mispredicted path. In this manner, any instructions for the current virtual thread that are younger than the instruction causing the exception or the misprediction will be re-executed, along with the torpedo instruction, when the current virtual thread (which is now being made inactive) is resumed.

From block 505, processing proceeds back to block 506. At block 506, if the torpedo point has been reached, processing proceeds to block 510.

FIG. 5 illustrates that blocks 510, 512 and 514 together illustrate at least one embodiment of further detail for the processing of block 208 illustrated in FIG. 2. Together, these blocks illustrate at least one embodiment of the processing for clearing 208 torpedoed instructions from the microarchitectural state of the processing system 400.

At block 510, a conversion is initiated in order to render processing of the current virtual thread, when it is resumed in the future, more efficient. That is, the load address for each load instruction in the execution pipeline has already been calculated. Accordingly, pending “torpedoed” load instructions are converted to prefetch instructions. Prefetch instructions, when executed, do not update the architectural state of the physical thread, but they do warm up the data cache 442 with the desired data.

One of skill in the art will recognize that the conversion 510 is an optional performance enhancement that need not necessarily be performed in order to practice the disclosed thread switching mechanism. The optional nature of the conversion 510 is indicated by broken lines in FIG. 5.

The conversion at block 510 may be accomplished in any of several manners. For example, the control logic 463 may indicate to a memory control system (not shown) that any unretired load instructions for the current virtual thread are to be re-classified. Such re-classification may be accomplished, for instance, by changing the value of a valid bit associated with each unretired load instruction in a memory system instruction queue (not shown). In addition, it may be desired, in order to fully accomplish the re-classification, that entries for pending load instructions for the current virtual thread be modified in any other microarchitectural structures, such as load request buffers, to reflect that the instruction should operate as a pre-fetch instruction rather than as a normal load instruction.

In this manner, the re-classification may indicate to a load/store execution unit (such as one of the execution units 160 shown in FIGS. 1 and 4), that the instruction should be treated as a prefetch instruction for data cache warm-up, and should not update the architectural state for the physical thread on which the current virtual thread is running.

An alternative approach for the conversion at block 510 may be accomplished by the memory system 441 rather than via operation of the control logic 463. For such alternative approach, each entry for an instruction (which may be a micro-operation) in an instruction queue (not shown) in the memory system 441 may include a virtual thread identifier. Responsive to receiving an indication that the current virtual thread is to be made inactive for a thread switch, the memory system 441 may re-classify each entry having the virtual thread identifier corresponding to the current virtual thread.

FIG. 5 illustrates that processing proceeds from block 510 to block 512. At block 512, all instructions for the current virtual thread which are younger than the torpedo instruction are “torpedoed”—they are cleared from the instruction pipeline of the processor. Processing then proceeds to block 514.

At block 514, torpedoed instructions are cleared from all microarchitectural resources, except that they are not cleared from store request buffers. However, all other execution resources pertaining to the torpedoed instructions are reclaimed. Torpedoed instructions are thus cleared, at block 514, from the reorder buffer 464, instruction queues, load request buffers, and the like.

As is stated above, the store request buffer entries for torpedoed instructions are not cleared at block 514. A typical implementation of a non-blocking cache mechanism may use store request buffers (“STRB's”) to track uncompleted memory requests. A store request in an STRB may have been retired but not yet written to the cache. The STRB entries for such instructions are allowed to remain active so that such cache update may occur as designed, even after the new virtual thread has begun execution.

From block 514, processing proceeds to block 516. FIG. 5 illustrates that blocks 514 and 516 together illustrate at least one embodiment of further detail for the processing of block 210 illustrated in FIG. 2. Together, these blocks 514, 516 illustrate at least one embodiment of the processing for modifying 210 the next instruction pointer for the physical thread to reflect the next instruction pointer for new virtual thread being switched to.

At block 514, the control logic 463 indicates to the front end 470 that the address of the torpedo instruction should be saved as the next instruction pointer value for the current virtual thread in the virtual IP table 124. Such torpedo instruction will be the first instruction executed when the current virtual thread is re-activated. Processing then proceeds to block 516.

At block 516, a new value for the next instruction pointer value for the physical thread undergoing the thread switch is determined and, accordingly, the next instruction pointer for the physical thread is modified. From FIG. 4, it can be seen that the physical thread and its sequencer 440 are in the front end 470 of the processor 404. Accordingly, block 516 may be performed by the front end 470 rather than being performed by the control logic 463. For at least one embodiment, such action 516 is performed by the front end 470 in response to a signal from the control logic 463.

For at least one embodiment, determination 516 of the new instruction pointer for the physical thread is made by retrieving the next instruction pointer for the new virtual thread from the virtual IP table 124. Processing then ends at block 520.

The foregoing discussion describes selected embodiments of methods, systems and apparatuses to provide low-overhead thread switching among virtual threads on one physical thread without disrupting operation on other physical threads. In the preceding description, various aspects of methods, system and apparatuses have been described. For purposes of explanation, specific numbers, examples, systems and configurations were set forth in order to provide a more thorough understanding. However, it is apparent to one skilled in the art that the described method and apparatus may be practiced without the specific details. In other instances, well-known features were omitted or simplified in order not to obscure the method and apparatus.

Embodiments of the method may be implemented in hardware, hardware emulation software, firmware, or a combination of such implementation approaches. Embodiments of the invention may be implemented for a programmable system comprising at least one processor, a data storage system (including volatile and non-volatile memory and/or storage elements), at least one input device, and at least one output device. For purposes of this application, a processing system includes any system that has a processor, such as, for example; a digital signal processor (DSP), a microcontroller, an application specific integrated circuit (ASIC), or a microprocessor.

A program may be stored on a storage media or device (e.g., hard disk drive, floppy disk drive, read only memory (ROM), CD-ROM device, flash memory device, digital versatile disk (DVD), or other storage device) readable by a general or special purpose programmable processing system. The instructions, accessible to a processor in a processing system, provide for configuring and operating the processing system when the storage media or device is read by the processing system to perform the procedures described herein. Embodiments of the invention may also be considered to be implemented as a machine-readable storage medium, configured for use with a processing system, where the storage medium so configured causes the processing system to operate in a specific and predefined manner to perform the functions described herein.

At least one embodiment of an example of such a processing system is shown in FIG. 4. Sample system 400 may be used, for example, to execute the processing for a method of torpedoing microarchitectural state for a virtual thread to facilitate a thread switch on one logical processor, without interrupting processing of one or more other logical processors. Sample system 400 is representative of processing systems based on the Pentium®, Pentium® Pro, Pentium® II, Pentium® III, Pentium® 4, and Itanium® and Itanium® II microprocessors available from Intel Corporation, although other systems (including personal computers (PCs) having other microprocessors, engineering workstations, personal digital assistants and other hand-held devices, set-top boxes and the like) may also be used. For one embodiment, sample system may execute a version of the Windows™ operating system available from Microsoft Corporation, although other operating systems and graphical user interfaces, for example, may also be used.

Referring to FIG. 4, sample processing system 400 includes a memory system 402 and a processor 404. Memory system 402 may store instructions 410 and data 412 for controlling the operation of the processor 404.

Memory system 402 is intended as a generalized representation of memory and may include a variety of forms of memory, such as a hard drive, CD-ROM, random access memory (RAM), dynamic random access memory (DRAM), static random access memory (SRAM), flash memory and related circuitry. Memory system 402 may store instructions 410 and/or data 412 represented by data signals that may be executed by processor 404. The instructions 410 and/or data 412 may include code for performing any or all of the techniques discussed herein.

While particular embodiments of the present invention have been shown and described, it will be obvious to those skilled in the art that changes and modifications can be made without departing from the present invention in its broader aspects.

Accordingly, one of skill in the art will recognize that changes and modifications can be made without departing from the present invention in its broader aspects. The appended claims are to encompass within their scope all such changes and modifications that fall within the true scope of the present invention.

1. An processor comprising:
a first logical processor to execute a first active software thread;
a second logical processor to execute a second active software thread; and
control logic to clear an unretired instruction for the first active thread from the processor;
wherein said clearing does not interrupt operation of the second logical processor.

2. The processor of claim 1, wherein:
the control logic is to clear said unretired instruction responsive to a thread switch indication for the first logical processor.

3. The processor of claim 1, wherein:
the control logic is to clear said unretired instruction from an execution pipeline.

4. The processor of claim 1, wherein:
the control logic is to clear said unretired instruction from a microarchitectural structure.

5. The processor of claim 4, wherein:
the microarchitectural structure further comprises an instruction queue to maintain instruction information for unscheduled instructions.

6. The processor of claim 4, further comprising:
the microarchitectural structure further comprises a load request buffer to maintain instruction information for uncompleted load instructions.

7. The processor of claim 1, wherein:
the control logic is to permit one or more uncompleted store instructions for the first active thread to remain pending in a store request buffer, where the store request buffer is to maintain instruction information for uncompleted store instructions.

8. The processor of claim 4, wherein:
the unretired instruction is a load instruction; and
the control logic is further to clear said unretired load instruction from said microarchitectural structure by converting the unretired load instruction to a prefetch instruction.

9. The processor of claim 1, further comprising:
a virtual instruction pointer table to store a next instruction pointer address for the first active thread.

10. The processor of claim 1, further comprising:
a torpedo pointer to indicate a torpedo instruction to be cleared.

11. The processor of claim 10, wherein:
said unretired instruction is younger, in program order, than the torpedo instruction.

12. A system comprising:
a memory system; and
a processor having M logical processors to support X software threads, where X≧M>2;
the processor further comprising control logic to clear an unretired instruction from the processor to facilitate a thread switch from an active one of the software threads to another of the software threads on a selected one of the logical processors;
wherein the control logic permits processing of non-selected logical processors to remain uninterrupted during the thread switch.

13. The system of claim 12, wherein:
the control logic is further to clear a plurality of non-worthwhile unretired instructions.

14. The system of claim 12, further comprising:
a torpedo pointer to indicate an oldest unretired instruction to be cleared for the active software thread.

15. The system of claim 12, further comprising:
a retirement buffer to track unretired instructions.

16. The system of claim 12, wherein:
the control logic is to permit worthwhile unretired instructions to retire before clearing the remaining unretired instructions.

17. The system of claim 12, wherein:
the control logic is further to convert an unretired load instruction for the active thread to a prefetch instruction.

18. The system of claim 12, wherein the processor further comprises:
a virtual instruction pointer table to maintain a next instruction pointer address for each inactive software thread.

19. The system of claim 12, wherein:
the memory system further comprises a dynamic random access memory.

20. A method, comprising:
determining a torpedo point to identify a torpedo instruction and a worthwhile instruction for a first software thread;
allowing completion of the worthwhile instruction;
clearing the torpedo instruction from a processor; and
modifying a next instruction pointer to reflect a next instruction to be executed for a second software thread.

21. The method of claim 20, further comprising:
re-determining the torpedo point responsive to an exception caused by the worthwhile instruction.

22. The method of claim 20, further comprising:
re-determining the torpedo point responsive to detection of a branch mis-prediction associated with the worthwhile instruction.

23. The method of claim 20, wherein allowing completion of the worthwhile instruction further comprises:
executing the worthwhile instruction.

24. The method of claim 20, wherein clearing the torpedo instruction from a processor further comprises:
clearing the torpedo instruction from an execution pipeline.

25. The method of claim 20, wherein clearing the torpedo instruction from a processor further comprises:
reclaiming all microarchitectural architectural resources associated with the torpedo instruction.

26. The method of claim 20, wherein:
the worthwhile instruction is a store instruction; and
clearing the torpedo instruction from a processor further comprises reclaiming all microarchitectural resources associated with the first software thread, except that a store request buffer entry for the store instruction is not reclaimed.

27. The method of claim 20, further comprising:
converting an unretired load instruction to a prefetch instruction, where the unretired load instruction is younger, in program order, than the torpedo instruction.

28. A method, comprising:
determining that a thread switch should occur from a current software thread to a new software thread for a first logical processor;
clearing non-worthwhile instructions from the microarchitectural state associated with the first logical processor; and
providing to the first logical processor an instruction pointer address for the new software thread;
wherein said clearing does affect the microarchitectural state associated with a second logical processor.

29. The method of claim 28, wherein:
said clearing non-worthwhile instructions further comprises clearing unretired instructions that are younger than an identified torpedo instruction.

30. The method of claim 29, wherein:
said clearing non-worthwhile instructions further comprises:
converting an unretired load instruction that is younger than the torpedo instruction to a prefetch instruction; and
clearing unretired non-prefetch instructions that are younger than the torpedo instruction.

31. The method of claim 28, wherein said clearing non-worthwhile instructions further comprises:
declining to reclaim a store request buffer entry for an uncompleted retired store instruction associated with the current software thread.

32. The method of claim 28, further comprising:
saving the address of an identified torpedo instruction as a next instruction pointer for the first software thread.
